(19) United States
(12) Patent Application Publication
(10) Pub. No.: US 2012/0320633 A1
(43) Pub. Date: Dec. 20, 2012

(54) VARIABLE FREQUENCY PWM SYNCHRONOUS RECTIFIER POWER SUPPLY

(76) Inventor: CHANG-HSING CHEN, NEW TAIPEI CITY (TW)

(21) Appl. No.: 13/161,585

(22) Filed: Jun. 16, 2011

(51) Int. Cl. H02M 3/335

(52) U.S. Cl. 363/21.01

(57) ABSTRACT

The present invention discloses a variable frequency PWM synchronous rectifier power supply comprising: a transformer, a PWM control circuit and a synchronous rectification switch circuit. The transformer has a primary side and a secondary side, and an isolation circuit is provided for separating the primary side and the secondary side, and the primary side uses a transmit/receive switch circuit to drive the transformer, and the secondary side uses a filter circuit to output different voltages to an external load. The PWM control circuit is situated on the secondary side and coupled to the isolation circuit and filter circuit, for generating a control signal to the isolation circuit to drive the transmit/receive switch circuit. The synchronous rectification switch circuit is situated on the secondary side and coupled to the PWM control circuit for receiving a timing delay control signal provided by the PWM control circuit.

### BACKGROUND OF THE INVENTION

1. Field of the Invention

The present invention relates to a pulse width modulation (PWM) power supply, in particular to a PWM power supply that uses a synchronous rectification switch circuit to perform a PWM at a secondary side of a transformer to drive one or more synchronous rectifier power supplies.

2. Description of the Related Art

With reference to FIG. 1 for s schematic circuit diagram of a high-efficiency push-pull power supply circuit as disclosed in R.O.C. Patent No. M335874, a PWM chip 82 is installed on a low voltage side 842 of an isolated driving transformer 84, and a transmit/receive switch circuit 85 is installed between a high voltage side 841 of the isolated driving transformer 84 and a high voltage side 811 of a transformer 81, and the PWM amplifier circuit 83 is installed between the low voltage side 842 of the isolated driving transformer 84 and the PWM chip 82, and an output rectifier circuit 86 is installed on a low voltage side 812 of the transformer 81. Since switching components Q1, Q2 of the transmit/receive switch circuit 85 are metal oxide field effect transistors (MOSFET), and the feature of the low power consumption of the field effect transistors is used to lower the switching loss of the switching components Q1, Q2, while the PWM chip 82 is installed on the low voltage side 842 of the isolated driving transformer 84 such that the PWM chip 82 can operated at a low voltage range to achieve the effect of preventing the high voltage side of the isolated driving transformer 84 from being affected by its high-voltage noises.

However, if an external load is dropped from a heavy load to a light load or no load, the switching frequency of a control signal of the PWM chip 82 is constant, so that the switching loss of the switching components Q1, Q2 of the transmit/receive switch circuit 85 cannot be reduced under the condition of any load, since the high-efficiency push-pull power supply circuit does not come with any inverter circuit or device. In addition, a rectifier circuit 86 connected to the low voltage side 812 of the transformer 81 is a diode, not only incurring higher manufacturing and material costs, but also causing a relatively high temperature by the low efficiency of rectification, and failing to achieve the synchronous rectification effect with the transmit/receive switch circuit 85 of the high voltage side 811.

The specification of the power transistors MOSFET Q1, Q2 is calculated by Iₚ₂×R_{DS(on)}×Tₒₙ×fₛ, wherein Iₚ is the primary side current of the transformer, R_{DS(on)} is the on-state resistance of the transistor Q1, Q2, Tₒₙ is the on-state time per duty cycle, and fₛ is the switching frequency. Therefore, this method is nothing more than (1) lowering fₛ or (2) lowering R_{DS(on)}. The formula given above can be applied to the duty cycle of the synchronous rectifiers SR1, SR2 with the same phase and same frequency, and the rectifier circuit 86 adopts the diodes D1, D2 with a loss equal to I_{D}×V_{F}×Tₛ×fₛ, wherein I_{D} is the current of the diode D1, D2, V_{F} is the forward-on voltage drop of the diode, and Tₛ is the discharge time of the secondary side. Therefore, this solution is to (1) lower fₛ or (2) lower V_{F}. Although a drop of switching frequency can reduce the switching loss, V_{F} is generally very large. For general Schottky diodes with a voltage over 0.35V, the synchronous rectification switching loss and conductive loss are much smaller than those of the diode rectifier circuit.

### SUMMARY OF THE INVENTION

Therefore, it is a primary objective of the present invention to provide a variable frequency PWM synchronous rectifier power supply, wherein an isolation circuit is provided for driving switching components of a transformer, as well as driving a frequency inversion pulse signal to drive synchronous rectification MOS transistors, in order to overcome the driving time problem and the phase loss of a synchronous rectification and reduce the switching loss of a rectification.

Another objective of the present invention is to provide a variable frequency PWM synchronous rectifier power supply, wherein one or more sets of frequency inversion pulse driving signals are outputted, such that the isolation component can drive the primary side switching components, and the synchronous frequency inversion pulse driving signal can drive one of more sets of synchronous rectifier circuits situated on the secondary side, and the synchronous rectification switch circuit coupled to the secondary side is designed and made of at least one MOS transistor to substitute the conventional diode rectifier circuit, so as to achieve the effects of lowering the manufacturing and material costs, improving the rectification efficiency, and reducing the temperature.

Another objective of the present invention is to provide a variable frequency PWM synchronous rectifier power supply, wherein the light load/heavy load proportion of a load is used for adjusting the frequency of an oscillation signal of an inverter circuit, such that the pulse signal of the PWM control circuit can achieve the frequency inversion effect.

To achieve the foregoing objectives, the invention provides a variable frequency PWM synchronous rectifier power supply comprising: a transformer, a PWM control circuit, a synchronous rectification switch circuit and an inverter circuit. The transformer has a primary side and a secondary side separated by an isolation circuit, and the primary side uses a transmit/receive switch circuit to drive the transformer, and the secondary side uses a filter circuit to output different voltages to an external load. The PWM control circuit is situated on the secondary side and coupled to the isolation circuit and the filter circuit, for generating a control signal to the isolation circuit to drive the transmit/receive switch circuit. The synchronous rectification switch circuit is situated on the secondary side and coupled to the PWM control circuit for receiving a timing delay control signal provided by the PWM control circuit.

### BRIEF DESCRIPTION OF THE DRAWINGS

FIG. 1 is a schematic circuit diagram of a high-efficiency push-pull power supply circuit as disclosed in R.O.C. Pat. No. M335874;

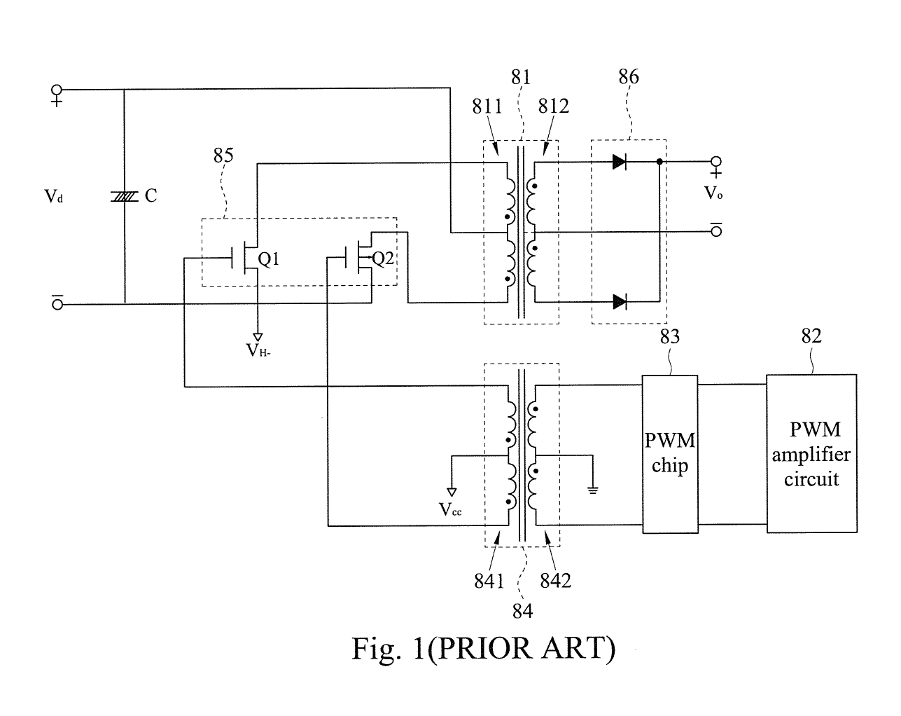

FIG. 2A is a schematic circuit diagram of a variable frequency PWM synchronous rectifier power supply in accordance with a first preferred embodiment of the present invention;

FIG. 2B is schematic block diagram of a variable frequency PWM synchronous rectifier power supply in accordance with a first preferred embodiment of the present invention;

FIG. 2C is a schematic circuit diagram of a PWM control circuit in accordance with a first preferred embodiment of the present invention;

FIG. 2D is a schematic circuit diagram of an inverter circuit in accordance with a first preferred embodiment of the present invention;

FIG. 3 is a timing chart of a transmit/receive switch circuit and a synchronous rectification switch circuit of the present invention;

FIG. 4A is a schematic block diagram of a variable frequency PWM synchronous rectifier power supply in accordance with a second preferred embodiment of the present invention;

FIG. 4B is a schematic circuit diagram of an invertible circuit in accordance with a second preferred embodiment of the present invention; and

FIG. 4C is a chart showing the inversion of an oscillation signal and a pulse signal of a variable frequency PWM synchronous rectifier power supply in accordance with a second preferred embodiment of the present invention.

### DETAILED DESCRIPTION OF THE PREFERRED EMBODIMENTS

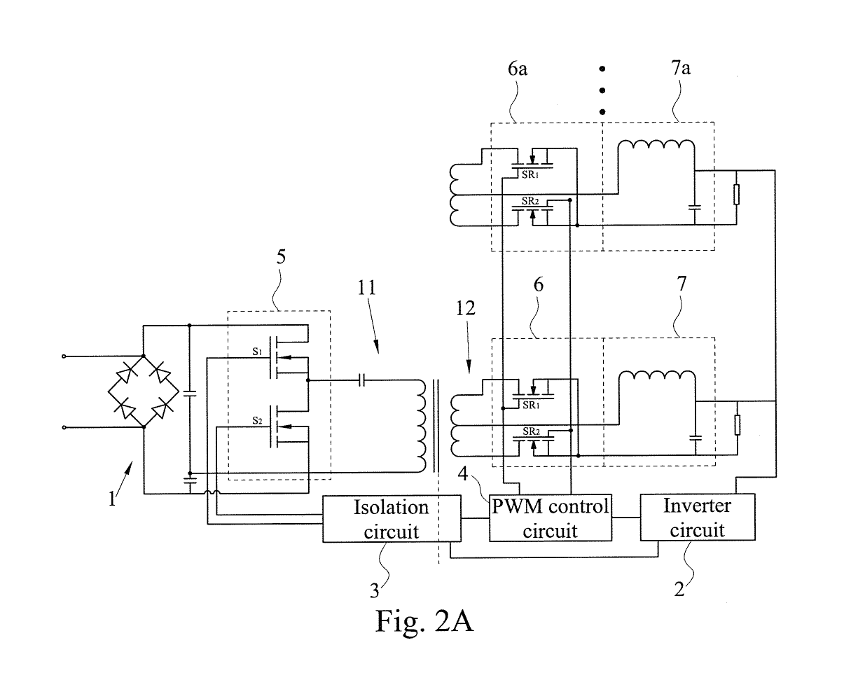

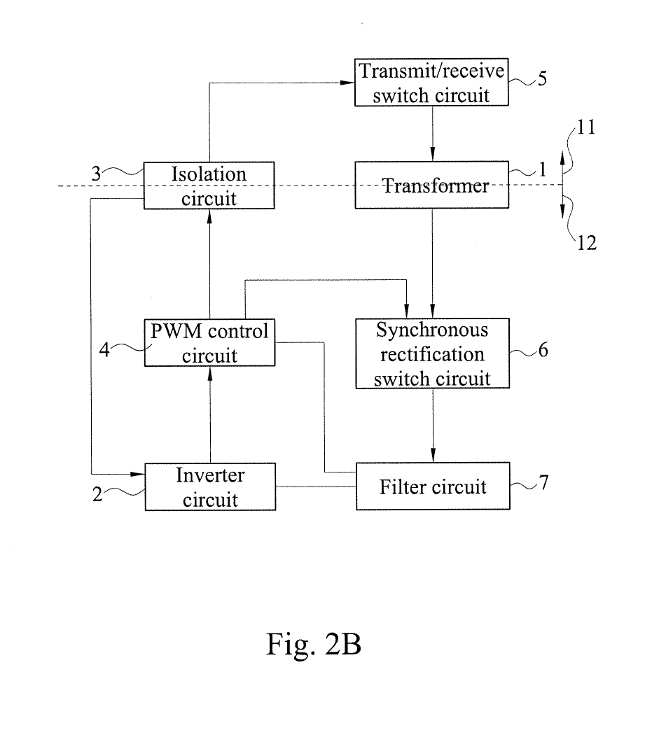

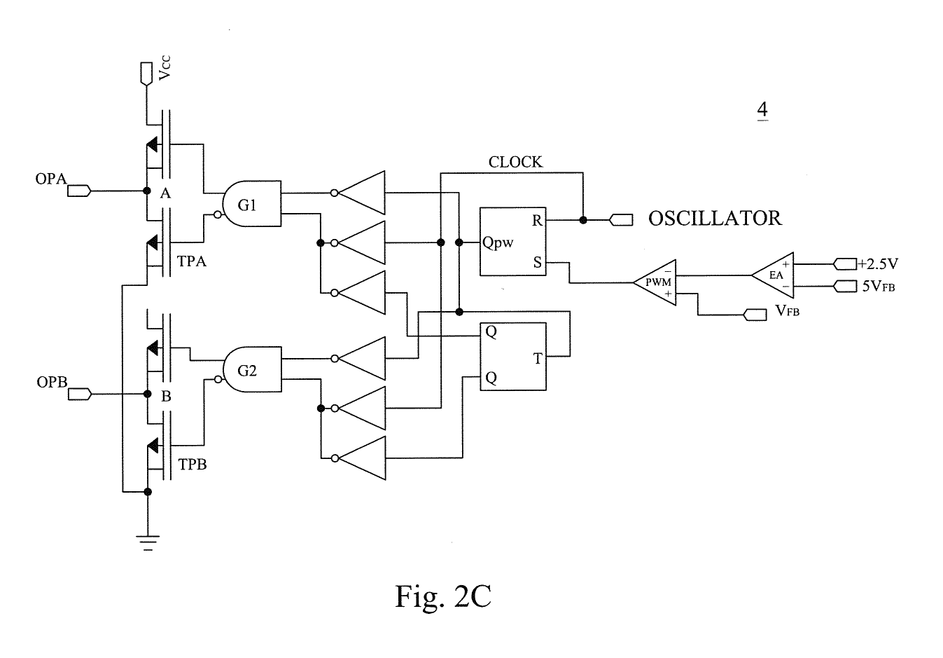

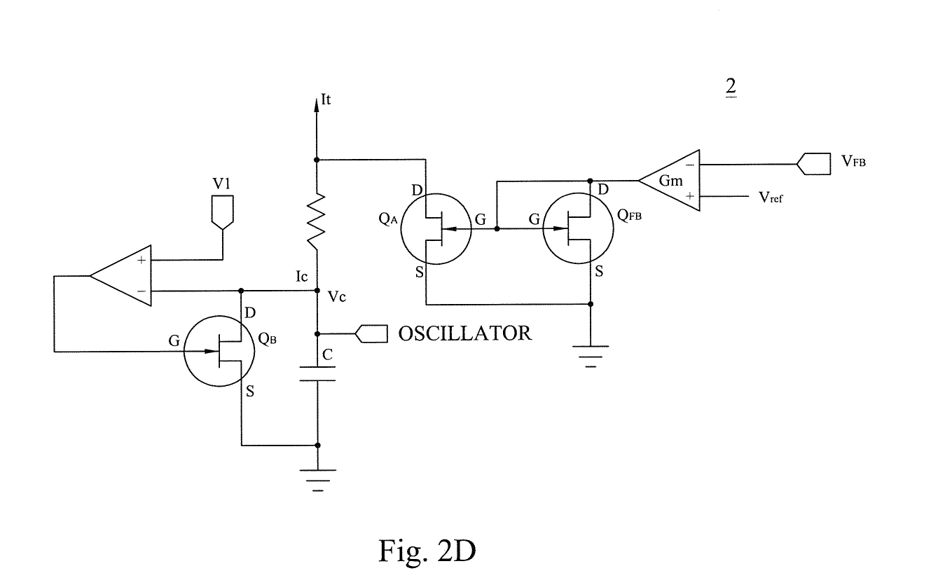

With reference to FIGS. 2A to 2D for a schematic circuit diagram and a schematic block diagram of a variable frequency PWM synchronous rectifier power supply, and schematic circuit diagrams of a PWM control circuit and an inverter circuit in accordance with a first preferred embodiment of the present invention respectively, the variable frequency PWM synchronous rectifier power supply of the present invention comprising: a transformer 1, a PWM control circuit 4 and a synchronous rectification switch circuit 6. The transformer 1 has a primary side 11 and a secondary side 12, and the transformer 1 can be a half-bridge transformer, a full-bridge transformer, a push-pull transformer, a converter transformer, a flyback transformer or a forward transformer. In a preferred embodiment of the present invention, the half-bridge transformer is used as an example for illustrating the present invention, and the half-bridge transformer is comprised of a set (two) of MOS transistors. If the flyback transformer or forward transformer is used instead, only one MOS transistor can be used for the operation. Persons ordinarily skilled in the art should understand that modifications and variations such as a change of quantity could be made without departing from the scope and spirit of the invention set forth in the claims. The primary side 11 and the secondary side 12 of the transformer 1 are separated by an isolation circuit 3, wherein the primary side 11 uses a transmit/receive switch circuit 5 to drive the transformer 1, and the transmit/receive switch circuit 5 includes at least one set of transmit/receive switch. For simplicity, the transmit/receive switch of this preferred embodiment of the present invention is a MOS transistor S1, S2, an insulated gate bipolar transistor (IGBT), or a bipolar junction transistor (BJT). The secondary side 12 uses a filter circuit 7 to output different voltages to an external load.

In this preferred embodiment of the present invention, the variable frequency PWM synchronous rectifier power supply further comprises an inverter circuit 2 situated on the secondary side 12 and coupled to the PWM control circuit 4 and the filter circuit 7. If the load feedback voltage V_{FB} of the inverter circuit 2 increases, the output current of Gm will increase accordingly. Now, the MOS transistor Q_{FB} is ON, and the MOS transistor Q_{A} is also ON, and the current passing through resistors will increase, and the capacitors are charged backward until V_{c} equals V₁, and the MOS transistor Q_{B} is ON, and the capacitors are discharged to 0 volt. Therefore, the change of V_{FB} can be used to adjusting the charging time to change the duty cycle. The internal voltage (V_{RE}) in the inverter circuit 2 can be adjusted to set the frequency level of the load or set the starting inversion range from 100%˜0% for different loads. If the starting range is set to 100%, then inversions at all bands can be achieved; or if the starting range is set to 0%, then no inversion can be achieved at any band, and in other words, no inverter circuit 2 is required. The inverter circuit 2 uses the change of an external load for the frequency inversion of a pulse signal of the PWM control circuit 4. Of course, the inverter circuit 2 can be coupled to the PWM control circuit 4 and the isolation circuit 3, and the inverter circuit 2 uses an isolation circuit 3 to change the load of the transmit/receive switch circuit 5 to achieve the frequency inversion of the pulse signal of the PWM control circuit 4.

The PWM control circuit 4 is situated on the secondary side 12 and coupled to the isolation circuit 3 and the filter circuit 7, and the PWM control circuit 4 generates a control signal to the isolation circuit 3 t drive the transmit/receive switch circuit 5. The PWM control circuit 4 uses an EA comparator to compare 2.5V and 5V_{FB} and generates a first compare signal, and then uses a PWM comparator to compares the first compare signal and V_{FB} to generate a second compare signal. Then, an oscillatory wave inputted at a terminal R of a SR flip-flop and a second compare signal inputted at a terminal S of the SR flip-flop can assure that the output of Qpw of the SR flip-flop is a rectangular pulse wave, and the output pulse wave of Qpw is based on the Hi/Low of the input terminal S (which is the second compare signal). A T-type flip-flop provides G1 or G2 and GATE to form a PWM, and positive and negative phases of the PWM give the asynchronous effect of the PWM. And then, six inverters are used for driving and enabling by a low potential. Now, the combination of G1 and A can be considered as synchronous rectification switch circuits 6 SR1, 6a SR1a, and the combination of G2 and B can be considered as synchronous rectification switch circuits 6 SR2, 6a SR2a. The synchronous rectification switch circuit 6 is situated on the secondary side 12 and coupled to the PWM control circuit 4. Of course, the PWM control circuit 4 also can be coupled to one synchronous rectification switch circuit 6 and one filter circuit 7. In this preferred embodiment of the present invention, the PWM control circuit 4 is coupled to two sets of synchronous rectification switch circuits 6, 6a and filter circuits 7, 7a at the same time.

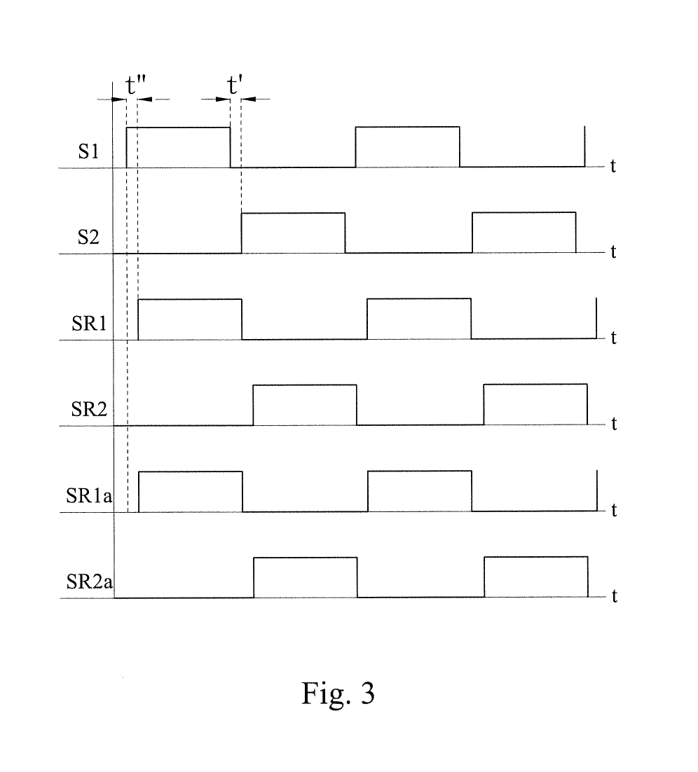

The synchronous rectification switch circuit 6 includes at least one set of MOS transistors SR1, SR2. With reference to FIG. 3 for the timing chart of a transmit/receive switch circuit and a synchronous rectification switch circuit in accordance with the present invention, when the MOS transistor S1 is ON, the MOS transistor S2 is not ON, and there is a DEAD TIME t′ between the alternate actions of S1 and S2 for preventing a short circuit of the transmit/receive switch circuit 5. The synchronous rectification switch circuit 6 receives a timing delay t″ provided by the PWM control circuit 4. The time difference between the process from adjusting the S1 and S2 pulse signals through the isolation circuit 3 to converting energy by the transformer 1 and the process of driving the pulse signal by synchronous rectification can synchronize the MOS transistors SR1, SR1a of the synchronous rectification switch circuit 6, 6a and the MOS transistor S1 of the transmit/receive switch circuit 5, as well as synchronizing the MOS transistors SR2, SR2a of the synchronous rectification switch circuit 6, 6a and the MOS transistor S2 of the transmit/receive switch circuit 5, and a switch can be achieved according to the winding method of the transformer 1. Such arrangement not only uses the inverter circuit 2 for the PWM, but also uses the synchronous rectification switch circuit 6 to drive the transformer 1 to achieve one or more synchronous rectifications. Of course, if the circuit condition is different, then not all synchronous actions require a timing delay t″. In some cases, no delay is required for a normal operation.

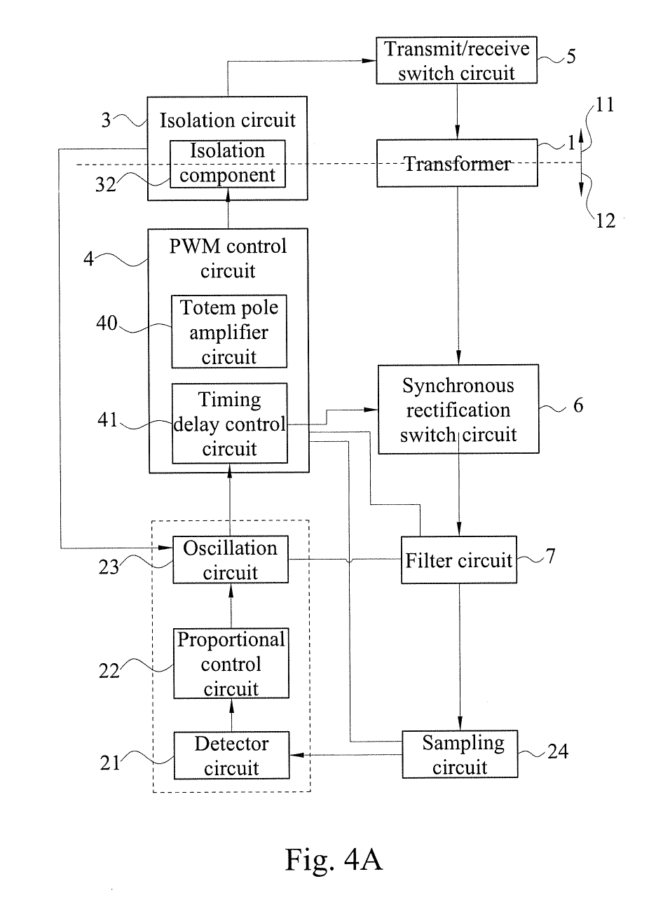

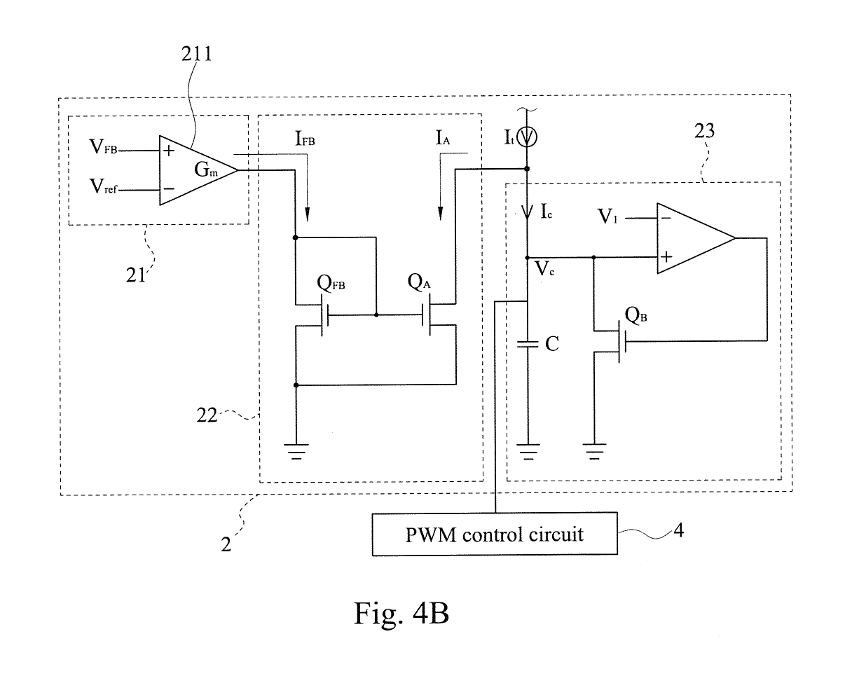

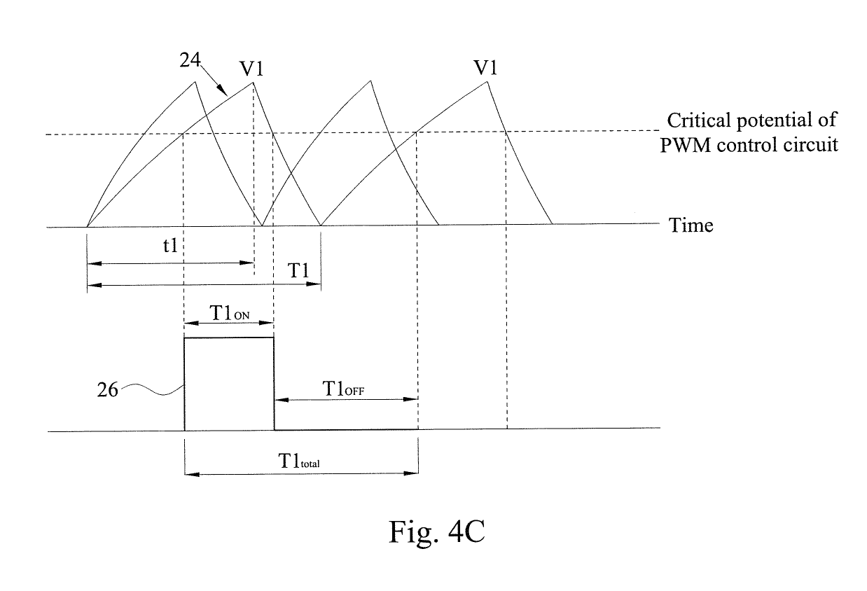

Most of the following components are substantially the same as those described above, and thus will not repeated here. With reference to FIGS. 4A to 4C for a block diagram of a PWM synchronous rectifier power supply, a schematic view of an operation of an inverter circuit, and a schematic view of frequency inversion of an oscillation signal and a pulse signal in accordance with a second preferred embodiment of the present invention respectively, the inverter circuit 2 includes a detector circuit 21, a proportional control circuit 22 and an oscillation circuit 23, and the detector circuit 21 is a voltage detection circuit or a current detection circuit, and a terminal of the proportional control circuit 22 is coupled to the detector circuit 21, and a terminal of the oscillation circuit 23 is coupled to the proportional control circuit 22, and the other terminal of the oscillation circuit 23 is coupled to the PWM control circuit 4.

In this preferred embodiment of the present invention, a sampling circuit 24 is installed between the filter circuit 7 and the secondary side 12 of the transformer 1, and a terminal of the sampling circuit 24 is coupled to the PWM control circuit 4, for sending a load condition detected by the sampling circuit 24 to the detector circuit 21 installed in the inverter circuit 2. With reference to FIG. 4B, the load feedback voltage V_{FB} of the input terminal of the detector circuit 21 can be used for obtaining the voltage reference of the load condition. Of course, the isolation circuit 3 can be used for obtaining the load condition of the transmit/receive switch circuit 5. Therefore, if the load drops, the load feedback voltage V_{FB} will drop. On the other hand, if the load rises, the load feedback voltage V_{FB} will rise. If the load feedback voltage V_{FB} drops, the internal voltage V_{ref} of the detector circuit 21 and the load feedback voltage V_{FB} can be compared, and a conversion element 211 is provided for converting the comparison result of the internal voltage V_{ref} and the load feedback voltage V_{FB} into a load current I_{FB} at the output terminal, and the load current I_{FB} and the load feedback voltage V_{FB} are inversely proportional to each other. Therefore, if the load drops, the load feedback voltage V_{FB} of the input terminal of the detector circuit 21 will drop, so that the load current I_{FB} of the output terminal of the detector circuit 21 will rise.

If the load current I_{FB} of the output terminal of the detector circuit 21 rises, and a terminal of the proportional control circuit 22 is coupled to the detector circuit 21, and a terminal of the oscillation circuit 23 is coupled to the proportional control circuit 22, the load current I_{FB} of the output terminal of the detector circuit 21 is passed into the MOS transistor Q_{FB} of the proportional control circuit 22 to electrically conduct the MOS transistor Q_{FB}, while a constant current Iₜ produces a current division, and a divided current I_{A} flows into the MOS transistor Q_{A} to electrically conduct the MOS transistor Q_{A} to decrease the charge current I_{C} of the oscillation circuit 23. In other words, the load current I_{FB} rises to control and decrease the charge current I_{C} of the oscillation circuit 23. Therefore, when the charge current I_{C} drops, the capacitor C of the oscillation circuit 23 is charged slowly, such that the voltage V_{C} of the capacitor C rises slowly, and the charging time t1 of the capacitor C increases. When the voltage V_{C} of the capacitor C is charged to a level equal to the internal voltage V₁, the voltage V_{C} of the capacitor C can discharge the MOS transistor Q_{B}, so that the oscillation circuit 23 generates an oscillation signal 24, and the cycle time T₁ increases. In the meantime, the cycle time T₁ and the frequency are inversely proportional to each other, and thus the frequency of the oscillation signal 24 is decreased to achieve the effect of reducing the frequency of the oscillation signal 24.

Since a terminal of the PWM control circuit 4 is coupled to the oscillation circuit 23 and the PWM control circuit 4 receives the oscillation signal 24 generated by the oscillation circuit 23, therefore when the frequency of the oscillation signal 24 is dropped, the on-state time T1_{ON} and the off-state time T1_{OFF} of the pulse signal 26 of the PWM control circuit 4 and the total cycle time T1 increase, and thus the duty cycle increases, and the frequency of the pulse signal 26 decreases. As a result, the effect of lowering the frequency of the pulse signal 26 can be achieved to perform a frequency inversion for the pulse signal 26 of the PWM control circuit 4.

A terminal of the isolation circuit 3 is coupled to the PWM control circuit 4, and the isolation circuit 3 includes an isolation component 32 for separating the primary side 11 and the secondary side 12, and the isolation component 32 has to convert a low voltage into a high voltage before it can drive the transmit/receive switch circuit 5. Therefore, a totem pole amplifier circuit 40 is added and installed onto the PWM control circuit 4, such that a transient current outputted by the isolation component 32 is supplied for driving the transmit/receive switch circuit 5 and inputted for the power required by the capacitor (Ciss), so as to drive the transmit/receive switch circuit 5 in an easier way. Finally, the totem pole amplifier circuit 40 is coupled to the PWM control circuit 4, and the PWM control circuit 4 is used for generating a control signal, and after the control signal is amplified by the totem pole amplifier circuit 40, the isolation circuit 3 receives the control signal to drive the transmit/receive switch circuit 5. Of course, the PWM control circuit 4 has a timing delay control circuit 41 for providing a timing delay control signal to the synchronous rectification switch circuit 6, or after the timing delay control signal is amplified by the totem pole amplifier circuit 40, the timing delay control signal is sent to the synchronous rectification switch circuit 6. The isolation component 32 can be an isolation transformer, an optical coupler, or a magnetic component. Therefore, the present invention can adjust the pulse signal 26 of the PWM control circuit 4 according to the light load/heavy load proportion of the load to achieve the frequency inversion effect, so as to lower the switching loss of the transmit/receive switch circuit 5 and the filter circuit 7 and improve the power-saving effect significantly.

What is claimed is:

1. A variable frequency pulse width modulation (PWM) synchronous rectifier power supply, comprising:
a transformer, having a primary side and a secondary side separated by an isolation circuit, and the primary side using a transmit/receive switch circuit to drive the transformer, and the secondary side using a filter circuit to output a different voltages to an external load;
a PWM control circuit, situated on the secondary side, and coupled to the isolation circuit and the filter circuit, for generating a control signal to the isolation circuit to drive the transmit/receive switch circuit; and
a synchronous rectification switch circuit, situated on the secondary side, and coupled to the PWM control circuit, for receiving a timing delay control signal provided by the PWM control circuit.

2. The variable frequency PWM synchronous rectifier power supply of claim 1, further comprising an inverter circuit, situated on the secondary side, and coupled to the PWM control circuit and the filter circuit, for inverting a pulse signal of the PWM control circuit by a change of an external load.

3. The variable frequency PWM synchronous rectifier power supply of claim 1, further comprising an inverter circuit, situated on the secondary side, and coupled to the PWM control circuit and the isolation circuit, for obtaining a change of a load of the transmit/receive switch circuit by the isolation circuit, to invert the pulse signal of the PWM control circuit.

4. The variable frequency PWM synchronous rectifier power supply of claim 1, wherein the synchronous rectification switch circuit includes at least one set of MOS transistors.

5. The variable frequency PWM synchronous rectifier power supply of claim 1, wherein the PWM control circuit includes a timing delay control circuit for providing the timing delay control signal to the synchronous rectification switch circuit.

6. The variable frequency PWM synchronous rectifier power supply of claim 1, wherein the inverter circuit further includes a detector circuit, a proportional control circuit and an oscillation circuit.

7. The variable frequency PWM synchronous rectifier power supply of claim 1, wherein the transmit/receive switch circuit includes at least one set of transmit/receive switches.

8. The variable frequency PWM synchronous rectifier power supply of claim 1, wherein the isolation circuit is capable of converting a low voltage into a high voltage to drive the transmit/receive switch circuit.

9. The variable frequency PWM synchronous rectifier power supply of claim 1, wherein the isolation circuit is one selected from the collection of an isolation transformer, an optical coupler and a magnetic component.
